(19) United States
(12) Patent Application Publication
(10) Pub. No.: US 2009/0023113 A1
(43) Pub. Date: Jan. 22, 2009

(54) Dental Appliance On-Line Ordering Including Display Of End Product Image And Mold Three-Dimensional Scanning For Digital Transmission

(75) Inventor: David T. Recigno, Willow Grove, PA (US)

Correspondence Address: FISH & RICHARDSON P.C., P.O. BOX 1022, MINNEAPOLIS, MN, 55440-1022, US

(73) Assignee: RECIGNO LABORATORIES, INC., Willow Grove, PA (US)

(21) Appl. No.: 12/028,391

(22) Filed: Feb. 8, 2008

Related U.S. Application Data
(63) Continuation of application No. 10/453,190, filed on Jun. 3, 2003, now abandoned.

(51) Int. Cl. A61C 5/10

(52) U.S. Cl. 433/223

(57) ABSTRACT

A method for on-line manufacturing of a dental appliance for the mouth of a patient, includes the steps providing a menu of questions to a user soliciting specifying information for specifying a manufacturing process to manufacture the dental appliance for the patient and producing a dental model of said mouth of said patient. The method also requires transmitting by said user said specifying information to a first manufacturing laboratory by way of the internet to create a user order for said dental appliance and transmitting said dental model by said user to said first manufacturing laboratory. The dental appliance is manufactured by said first manufacturing laboratory in accordance with said fitted specifying information and said transmitted model to provide a manufactured dental appliance.

### BACKGROUND OF THE INVENTION

1. Field of Invention

To automate the manufacturing of dental appliances in order to produce dental appliances more efficiently.

2. Description of Related Art

For example, the Abstract of Japanese Patent Application No. 2001145646 discloses a computer-aided design system for a dental prosthesis. In this system a client computer communicates with a server computer by way of the internet. The client computer includes a client automatic design part which automatically creates data the shape of the dental prosthesis based on a dental prosthesis specification. The specification is received by way of a specification input interface within the client computer from the server computer (which is accessed to according to speech conditions put in through the specification input interface).

The Abstract of Japanese Patent Application No. 2000272886 discloses a dental clinic introduction system for providing advice to users regarding teeth. An in-mouth photographic image of an examinee is sent from the user to a mediator through the internet. The mediator obtains a review of the image by a dentist or dental hygienist, informs the examinee of the judgment and suggests a clinic.

U.S. Pat. No. 6,540,512 discloses a system in which a site orthodontic system transmits digital information regarding an orthodontic patient to a server by way of a communication network. The server creates an electronic patient record from the transmitted information. The server also generates a treatment plan for the patient. The treatment plan is transmitted to the site orthodontic system.

U.S. Pat. No. 6,394,800 discloses a system for processing orders for supplying orthodontic bands wherein a customer order is received and stored in a computer. The order information can include image information A printer is provided for supplying printed order information to the computer. The order information is checked to determine whether it includes valid data for specifying a band A band is then provided according to the order information and loaded into a transport container.

U.S. Pat. No. 5,882,192 discloses a computerized orthodontic diagnosis and appliance dispenser in which an apparatus for measuring teeth and determining the orthodontic conditions of a patient is provided. A storage chamber within the device holds a plurality of orthodontic appliances. An appliance is selected and dispensed according to the patient information. A digital image camera and/or a video camera is included for providing data A touch screen is provided for receiving the patient information and to assist in performing the diagnosis.

However, none of the foregoing references, devices or systems are effective in using the internet to specify, order, manufacture and track the ordering and manufacturing of dental appliances, or in providing a menu to permit a customer to specify dental appliances.

### BRIEF SUMMARY OF THE INVENTION

A method for on-line manufacturing of a dental appliance for the mouth of a patient includes the steps providing a menu of questions to a user soliciting specifying information for specifying a manufacturing process to manufacture the dental appliance for the patient and producing a dental model of said mouth of said patient. The method also requires transmitting by said user said specifying information to a first manufacturing laboratory by way implementation of the internet to create a user order for said dental appliance and transmitting said dental model by said user to said first manufacturing laboratory. The dental appliance is manufactured by said first manufacturing laboratory in accordance with said transmitted specifying information and said transmitted model to provide a manufactured dental appliance.

### BRIEF DESCRIPTION OF SEVERAL VIEWS OF THE DRAWINGS

FIG. 1 shows a flow chart representation of the on-line dental appliance manufacturing system of the present invention.

FIG. 2 shows a block diagram representation of a process flow of the on-line dental appliance manufacturing system FIG. 1.

FIG. 3 shows an alternate embodiment of the on-line dental appliance manufacturing system of FIG. 1.

FIG. 4 shows a block diagram representation of a process flow of the on-line dental appliance manufacturing system of FIG. 3.

FIG. 5 shows a block diagram representation of a process flow of an alternate embodiment of the on-line dental appliance manufacturing system of FIG. 1.

FIG. 6 shows a block diagram representation of a process flow of an alternate embodiment of the on-line dental appliance manufacturing system of FIG. 1.

### DETAILED DESCRIPTION OF THE INVENTION

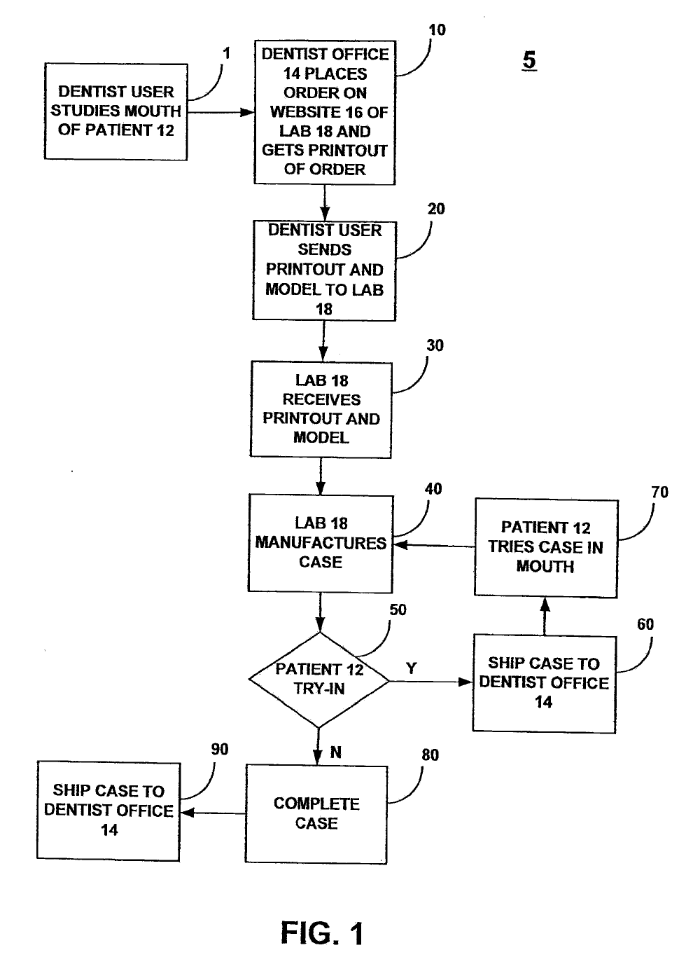

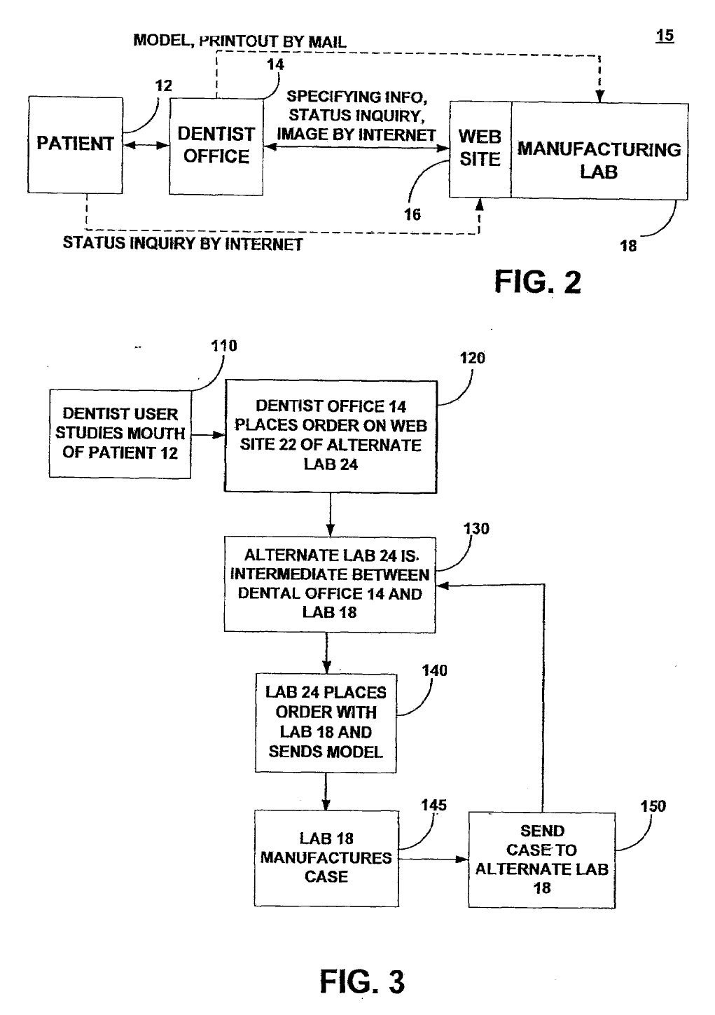

Referring now to FIGS. 1, 2, there is shown the flow chart representation of the dental appliance on-line manufacturing system 5 and a block diagram representation of the process flow 15 of the present invention. The on-line dental appliance manufacturing system 5 permits the use of an internet connection to perform operations such as creating an order for the manufacture of a dental appliance, determining the status of such an order for a dental appliance, modifying such an order, and paying for such an order, for example, paying by credit card, account status, prescription forms, shipping labels, technical support case evaluation, schedule pickup all by way of the internet connection. In addition, the user name and address is pre-loaded by the computer to save time and retyping of information by the user.

The user of the on-line dental appliance manufacturing system 5 can be a dentist having the knowledge of one skilled in the art of the dental appliances which are available for ordering appliances using the on-line dental appliance manufacturing system 5. In accordance with the on-line manufacturing system 5, as shown in FIG. 1, the dentist user of system 5, or some other dentist, meets with the patient 12 and studies the mouth of the patient 12 in a dentist office 14. In this manner, the dentist user obtains the required knowledge of the specifications of the dental appliance being ordered using the on-line manufacturing system 5. Furthermore, the dentist user determines a prescription for a custom design dental prosthetic to be ordered in accordance with the study of the mouth of the patient shown in block 1.

The dentist user specifies a dental appliance to be obtained using on-line manufacturing system 5 according to the prescription determined in this manner. The specifying process is an interactive, menu-driven, question-and-answer process for specifying the configuration of the dental appliance. The specifying process is know as variant configuring. In the variant configuring process, a product is customized by the dentist user through the answers to the series of questions provided in the menu. An example of a series of questions which may appear in this process is shown in the Addendum to the Appendix attached hereto.

Pursuant to block 10 of the on-line manufacturing system 5, the dentist clicks onto and connects with the web site 16 of the manufacturing laboratory 18 performing the manufacturing of the dental appliance which was ordered in accordance with the on-line manufacturing system 5. The manufacturing laboratory 18 can be a conventional dental appliance manufacturing laboratory 18 capable of manufacturing dental appliances such as restorations, dentures, partials, crowns, bridges, and implants. The appliance manufacturing laboratory 18 in this manner is known as a case. In response to the order of block 10, the manufacturing laboratory 18 can send an acknowledgment to the dentist user.

As also shown in block 10, the dentist user can make multiple printouts of the order thus placed with the manufacturing laboratory 18 by way of the internet and the web site 16 of the manufacturing laboratory 18. At least one copy of the printout can be sent to the manufacturing laboratory 18 by the dentist user as shown in block 20. At least one copy can be retained by the dentist user. During the visit of the patient 12 to the dentist office 14, a model of the teeth of the patient 12 can be created by the dentist user. The dental model created in this manner can be transmitted by way of the mail or other courier to the manufacturing laboratory 18 as well as the printout by the dentist user as shown in block 20.

In the preferred embodiment of the invention, the manufacturing process performed by the manufacturing laboratory 18 to provide the specified dental appliance does not begin until the copy of the printout and the model are received by the manufacturing laboratory 18. The process of manufacturing the dental appliance is facilitated by providing time for the manufacturing laboratory 18 to make any preliminary scheduling or material requirement preparations that may be useful and to have all of the required parameters specified when the dental model arrives. Furthermore, the production error rate is decreased by forcing the dentist user to completely formulate and provide the specifying information at the beginning of the process. The method set forth for operating on-line manufacturing system thus results in faster turnaround, as well as increased accuracy. Additionally, this method of ordering is much faster for the dentist user since it permits the use of computer-check off techniques rather than the laborious writing of the prescription by hand.

As shown in 30, 40, when the manufacturing laboratory 18 receives the printout or electronic representation of the printout and the model transmitted by the dentist user in accordance with block 20, it proceeds to the manufacturing of the case specified thereby. The manufacturing process performed in block 40 of the on-line manufacturing system 5 can be any type of manufacturing process effective to produce the prescribed dental appliance according to the specifying information transmitted from the dentist user to the manufacturing laboratory 18 by way of the web site 16.

In decision 50 of the on-line manufacturing system 5, a determination is made whether the patient 12 of the dentist user must test the manufactured case by trying it in his or her mouth prior to completion of the manufacturing process by the manufacturing laboratory 18. If such a patient try-in is required, their execution of the on-line manufacturing system 5 proceeds to block 60 where the dental appliance is shipped to the dentist office 14 to permit the patient 12 to try the case in his or mouth as shown in block 70. After the try-in of blocks 60, 70, execution of the on-line manufacturing system 5 returns to block 40 for further manufacturing operations.

The dentist user may provide adjusted specifying information according to the patient try-in. Thus, the manufacturing laboratory 18 may continue the manufacturing process according to the adjusted specifying information transmitted to it by the dentist user.

If a determination is made in decision 50 that the case being manufactured according to the present invention is not a patient try-in, then the manufacturing of the case by the on-line manufacturing system 5 is completed without first shipping it to the dentist user as shown in block 80. The completed case is thus shipped to the dentist office 14 as shown in block 90.

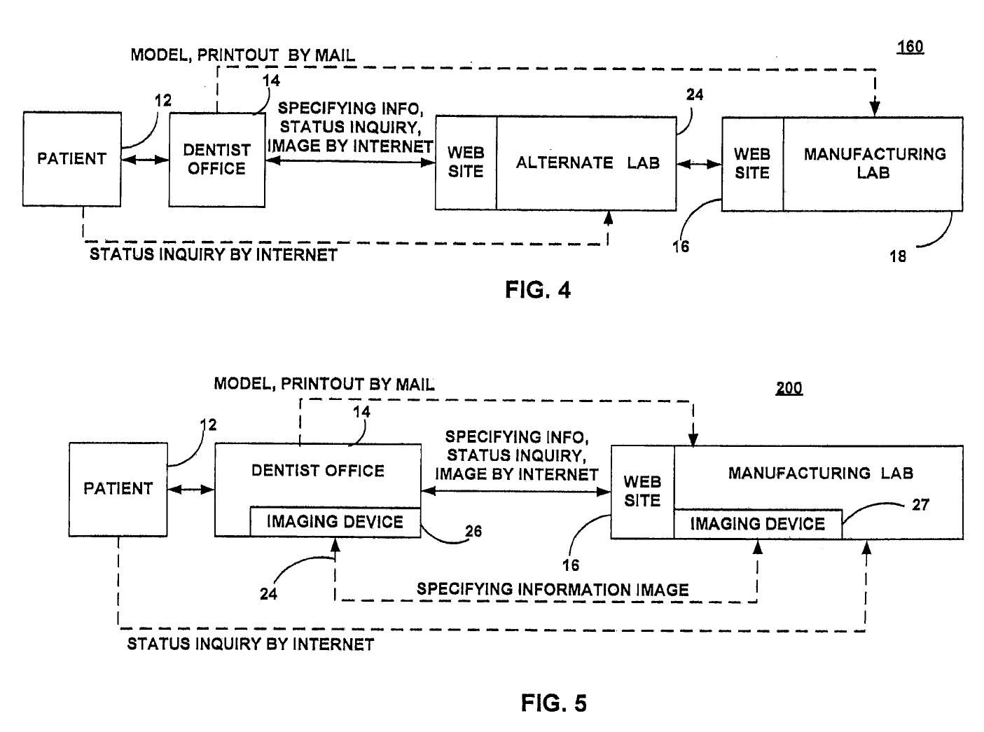

Referring now to FIGS. 3, 4, there are shown a flow chart representation of the on-line dental appliance manufacturing system 100 and a block diagram representation of the process flow 160. The on-line dental appliance manufacturing system 100 is an alternate embodiment of the on-line dental appliance manufacturing system 5, wherein an alternate laboratory 24 provided within the online manufacturing system 100 receives the user order from the dentist user and forwards the user order to the manufacturing laboratory 18.

When the manufacturing laboratory 18 receives the user order from the alternate laboratory 24, it can process it substantially as described with respect to the processing of the on-line manufacturing system 5. An exception is that communication between the manufacturing laboratory 18 and the dentist office 14 is replaced with communication between the alternate laboratory 24 and the dentist office 14, while all communication with the manufacturing laboratory 18 is handled by the alternate laboratory 24. On-line manufacturing system 100 is useful, for example, when the dentist user places an order for a specialized case wherein the manufacturing laboratory 18 is better equipped than the alternate laboratory 24 to provide more specialized expertise required to produce the case.

In the on-line manufacturing system 100 the dentist user studies the mouth of the patient 12 as shown in block 110. The dentist office 14 places an order with the alternate laboratory 24 in accordance with a study of the mouth of the patient as shown in block 120 in any manner that is convenient. For example, the dentist office 14 can mail a copy of a handwritten prescription to the alternate laboratory 24 or transmit specifying information by way of the web site 22 of the alternate laboratory 24. This step can include transmitting a dental model as well as specifying information as previously described with respect to the on-line manufacturing system 5.

The alternate laboratory 24 can thus serve as an intermediary between the dentist office 14 and the manufacturing laboratory 18 shown in block 130. Accordingly, the alternate laboratory 24 places the user order received from the dentist user with the manufacturing laboratory 18 as shown in block 120. Additionally, the alternate laboratory 24 transmits the model received from the dentist user to the manufacturing laboratory 18 as shown in block 130. In block 140, the manufacturing laboratory 18 manufactures the case according to the specifying information and traits the case to the alternate laboratory 24 for transmission to the dentist office 14 in substantially the manner previously described.

Although it is not shown in detail in FIG. 3, in order to simplify the drawing, the on-line manufacturing method 100 can include all of the features set forth herein with respect to the various alternate embodiments, including the on-line manufacturing method 5. For example, the on-line manufacturing method 100, can include the patient try-in feature described above wherein the case is shipped back to the dentist office 14 prior to the completion of the manufacturing process.

Referring now to FIG. 5, there is shown a block diagram representation of a process flow 200. The process flow 200 is substantially similar to the process flows 15, 160 with the exception, that in the process flow 200, the dentist office 14 and the manufacturing laboratory 18 are provided with imaging devices 26, 27, respectively. Additionally, an image transmission path between the manufacturing laboratory 18 and the dentist office 14 is provided. The image transmission path 24 can be provided by way of the internet.

In the process flow 200, the manufacturing laboratory 18 receives the specification of the dental appliance from the dentist office 14 as previously described. The manufacturing laboratory 18 can then use the imaging device 27 to create a projected image of the results of the manufacturing process according to the specifying information. The manufacturing laboratory 18 can then transmit the projected image to the dentist office 14 by way of the image transmission path 24. Alternately, the dentist office 14 can use the imaging device 26 to create an image directly from the specify information, independently of any transmission of the specifying information to the manufacturing laboratory 18.

This feature of the system of the present invention further decreases the likelihood that the finished product may be returned after it is received by the dentist user.

An image, transmitted by way of the image transmission path 24, can be transmitted at the time the specifying information is provided to the manufacturing laboratory and/or during the manufacturing process or at any other time. Thus, the dentist user can review the image received from the manufacturing laboratory 18 in this manner and adjust or modify the specifying information accordingly. The adjusted specifying information can be transmitted by the dentist user to the manufacturing laboratory 18 by way of the web site 16. The manufacturing laboratory 18 can then perform the manufacturing process according to the adjusted specifying information.

The dentist office 14 and the manufacturing laboratory 18 can use the imaging device 26 to create images of cross-sectional views, perspective views, views with shading, or cut-away views of the case in any of its partially completed stages of manufacture. Furthermore, any kinds of images or views that may be useful for the on-line dental appliance manufacturing system 5 can be created and transmitted between the dentist user and the manufacturing laboratory 18.

With respect to the operations of the imaging devices 26, 27, third party software packages capable of performing the operations described are commercially available. For example, Quark Express and Graphic Design provide packages suitable for created the views described from the specifying information.

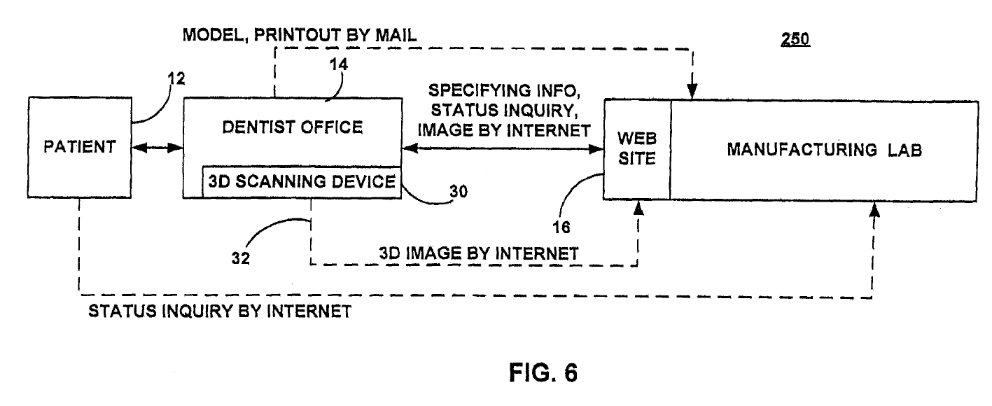

Referring now to FIG. 6, there is shown a block diagram representation of the process flow 250. The process flow 250 is substantially similar to the process flows 15, 160 corresponding to the on-line dental appliance manufacturing systems 15, 100, with the exception of the addition of three-dimensional scanner 30 within the dentist office 14 and an image transmission path 32. Transmission of an image by way of an image transmission path 26 from the dentist office 14 to the web site 16 and backend computer processing system of the manufacturing laboratory 18 is also provided in the process flow 250.

In one embodiment of the process flow 250, the dentist user takes an impression (analog or digital) of the patient's mouth and makes a model of the mouth of the patient 12 as previously described. The dentist user then scans the dental model using the three-dimensional scanner 30. The output of the three dimensional scanner 30 is an electronic representation of the dental model that can be used by the manufacturing laboratory 18 to manufacture a case as set forth above with respect to blocks 2040 of the on-line manufacturing system 5. Alternately, a laser or other type of scan of the mouth of a patient can be performed to obtain an electronic representation of the mouth of the patient in either embodiment, the electronic representation of the patient's mouth can be used by the manufacturing laboratory 18 to begin some manufacturing operations without waiting for the arrival of the dental model itself. Alternately, the electronic representation received by way of the image transmission path 32 can replace the dental model entirely in the manufacturing process.

Software and hardware systems capable of performing the operations of the three-dimensional scanner 30 are known in the art and are commercially available. For example, Versa Laser produces a package suitable for providing the electronic representations transmitted by way of the image transmission path 32.

While the invention has been described in detail and with reference to specific examples thereof, it will be apparent to those skilled in the art that various changes and modifications can be made therein without departing from the spirit and scope thereof.

What is claimed is:

1. A method for on-line manufacturing of a dental appliance for the mouth of a patient, comprising the steps of:
(a) providing a menu of questions to a user soliciting specifying information for specifying a manufacturing process to manufacture said dental appliance for said patent;
b) producing a dental model of said mouth of said patient;
(c) transmitting by said user said specifying information to a first manufacturing laboratory by way of the internet to create a user order for said dental appliance;
(d) transmitting said dental model by said user to said first manufacturing laboratory, and
(e) manufacturing said dental appliance by said first manufacturing laboratory in accordance with said transmitted specifying information and said transmitted model to provide a manufactured dental appliance.

2. The method for on-line manufacturing of a dental appliance for the mouth of a patient of claim 1, comprising the further step of providing a user order number corresponding to said user order.

3. The method for on-line manufacturing of a dental appliance for the mouth of a patient of claim 2, comprising the further step of providing to said user an order printout including within said order printout said user order number corresponding to said user order.

4. The method for on-line manufacturing of a dental appliance for the mouth of a patient of claim 1, comprising the further steps of:
(a) transmitting said order printout to said first manufacturing laboratory by said user, and
(b) manufacturing said dental appliance by said f manufacturing laboratory only when said first manufacturing laboratory receives said order printout.

5. The method for on-line manufacturing of a dental appliance for the mouth of a patient of claim 1, wherein said menu comprises a list of questions adapted to configure said manufactured dental appliance.

6. The method for on-line manufacturing of a dental appliance for the mouth of a patient of claim 1, wherein said step of manufacturing said dental appliance comprises an appliance completion step for completing said manufacturing of said dental appliance.

7. The method for on-line manufacturing of a dental appliance for the mouth of a patient of claim 6, wherein the step of manufacturing the dental appliance comprises the farther step of transmitting said manufactured dental appliance by said first manufacturing laboratory to said user after said appliance completion step.

8. The method for on-line manufacturing of a dental appliance for the mouth of a patient of claim 7, comprising the further steps of:
(a) first transmitting said dental appliance by said first manufacturing laboratory to said user prior to said completion step;
(b) trying said dental appliance in said mouth of said patient; and
(c) second transmitting said dental appliance by said user to said first manufacturing laboratory to provide a second transmitted dental appliance.

9. The method for on-line manufacturing of a dental appliance for the mouth of a patient of claim 8, further comprising the further step of performing said appliance completion step upon said second transmitted dental appliance.

10. The method for on-line manufacturing of a dental appliance for the mouth of a patient of claim 9, comprising the further steps of:
(a) modifying said specifying information by said user in accordance with said trying of said dental appliance in said mouth of said patient to provide modified specifying information;
(b) transmitting said modified specifying information by said user to said first manufacturing laboratory, and
(c) performing said appliance completion step upon second transmitted dental appliance in accordance with said modified specifying information.

11. The method for on-line manufacturing of a dental appliance for the mouth of a patient of claim 2, comprising the further step of manufacturing said dental appliance in accordance with said user case number.

12. The method for on-line manufacturing of a dental appliance for the mouth of a patient of claim 11, comprising the further step of tracking said manufacturing of said user order in accordance with said case number.

13. The method for on-line manufacturing of a dental appliance for the mouth of a patient of claim 12, comprising the further step of tracking said manufacturing of said user order by said patient in accordance with said case number.

14. The method for on-line manufacturing of a dental appliance for the mouth of a patient of claim 12, comprising the further step of tracking said manufacturing of said user order by said user in accordance with said case number.

15. The method for on-line manufacturing of a dental appliance for the mouth of a patient of claim 1, including a specifying information receiving entity for receiving said specifying information from said user and transmitting said specifying information to said first manufacturing laboratory.

16. The method for on-line manufacturing of a dental appliance for the mouth of a patient of claim 15, comprising the further step of receiving said dental model by said specifying information receiving entity and transmitting said dental model to said first manufacturing laboratory by said specifying information receiving entity.

17. The method for on-line manufacturing of a dental appliance for the mouth of a patient of claim 16, wherein said specifying information receiving entity comprises a second manufacturing laboratory.

18. The method for on-line manufacturing of a dental appliance for the mouth of a patient of claim 1, comprising the further step of determining a dental appliance image of said dental appliance in accordance with said specifying information.

19. The method for on-line manufacturing of a dental appliance for the mouth of a patient of claim 18, comprising the further step of determining said dental appliance image of said manufactured dental appliance in accordance with said specifying information.

20. The method for on-line manufacturing of a dental appliance for the mouth of a patient of claim 18, comprising the further step of determining said dental appliance image of a portion of said manufactured dental appliance in accordance with said specifying information.

21. The method for on-line manufacturing of a dental appliance for the mouth of a patient of claim 18, comprising the further steps of:
(a) determining said dental appliance image by said first manufacturing laboratory, and
(b) transmitting said dental appliance image by said first manufacturing laboratory to said user.

22. The method for on-line manufacturing of a dental appliance for the mouth of a patient of claim 18, comprising the further steps of:
(a) determining said dental appliance image by said user, and
(b) transmitting said dental appliance image by said user to said first manufacturing laboratory.

23. The method for on-line manufacturing of a dental appliance for the mouth of a patient of claim 21, comprising the further step of adjusting said specifying information by said user in accordance with said dental appliance image to provide adjusted specifying information.

24. The method for on-line manufacturing of a dental appliance for the mouth of a patient of claim 23, comprising the flier step of transmitting said adjusted specifying information to said first manufacturing laboratory by said user to provide transmitted adjusted specifying information.

25. The method for on-line manufacturing of a dental appliance for the mouth of a patient of claim 24, comprising the further step of manufacturing said dental appliance by said first manufacturing laboratory in accordance with said transmitted adjusted specifying information.

26. The method for on-line manufacturing of a dental appliance for the mouth of a patient of claim 1, comprising the further steps of:
(a) determining a dental model image of said dental model by said user, and
(b) transmitting said dental model image to said first manufacturing laboratory by said user to provide a transmitted dental model image.

27. The method for on-line manufacturing of a dental appliance for the mouth of a patient of claim 26, wherein said dental model image comprises a three-dimensional image dental model image.

28. The method for on-line manufacturing of a dental appliance for the mouth of a patient of claim 26, comprising the further step of manufacturing said dental appliance by said first manufacturing laboratory in accordance with said transmitted dental model image.

29. The method for on-line manufacturing of a dental appliance for the mouth of a patient of claim 1, wherein said manufactured dental appliance comprises a removable restoration.

30. The method for on-line manufacturing of a dental appliance for the mouth of a patient of claim 1, wherein said manufactured dental appliance comprises a fixed restoration.

31. The method for on-line manufacturing of a dental appliance for the mouth of a patient of claim 1, wherein said user comprises a dentist.

32. A method for on-line manufacturing of dental appliances for the mouth of a patient, comprising the steps of:
(a) providing a menu of questions to a user soliciting specifying information for specifying a manufacturing process to produce said dental appliance for said patient;
(b) transmitting by said user said specifying information to a manufacturing laboratory by way of the internet to create a user order for said dental appliance;
(c) determining a dental appliance image of said dental appliance in accordance with said specifying information; and
(d) manufacturing said dental appliance by said manufacturing laboratory in accordance with said transmitted specifying information to provide a manufactured dental appliance.

33. The method for on-line manufacturing of a dental appliance for the mouth of a patient of claim 32, comprising the further step of determining said dental appliance image by said manufacturing laboratory and transmitting said dental appliance image by said manufacturing laboratory to said user.

34. The method for on-line manufacturing of a dental appliance for the mouth of a patient of claim 32, comprising the fiercer step of determining said dental appliance image by said user and transmitting said dental appliance image by said user to said manufacturing laboratory.

35. The method for on-line manufacturing of a dental appliance for the mouth of a patient of claim 33, comprising the further steps of:
(a) receiving said dental appliance image by said user; and
(b) adjusting said specifying information in accordance with said dental appliance image to provide adjusted specifying information.

36. The method for on-line manufacturing of a dental appliance for the mouth of a patient of claim 35, comprising the further step of transmitting said adjusted specifying information to said manufacturing laboratory by said user to provide transmitted adjusted specifying information.

37. The method for on-lie manufacturing of a dental appliance for the mouth of a patient of claim 36, comprising the further step of manufacturing said dental appliance by said manufacturing laboratory in accordance with said transmitted adjusted specifying information.

38. The method for on-line manufacturing of a dental appliance for the mouth of a patient of claim 32, comprising the fierier steps of:
(a) producing a dental model of said mouth of said patient by said user;
(b) transmitting said dew model by said user to said manufacturing laboratory; and
(c) manufacturing said dental appliance by said manufacturing laboratory in accordance with said transmitted model.

39. The method for on-line manufacturing of a dental appliance for the mouth of a patient of claim 32, comprising the further step of determining said dental appliance image of said manufactured dental appliance in accordance with said specifying information.

40. The method for on-line manufacturing of a dental appliance for the mouth of a patient of claim 32, comprising the further step of determining said dental appliance image of a portion of said manufactured dental appliance in accordance with said specifying information.

41. The method for on-line manufacturing of a dental appliance for the mouth of a patient of claim 38, comprising the further step of determining a three-dimensional dental model image of said dental model by said user and transmitting said dental model image to said manufacturing laboratory by said user.

42. The method for on-line manufacturing of a dental appliance for the mouth of a patient of claim 41, comprising the further step of manufacturing said dental appliance in accordance with said transmitted three dimensional dental model image by said manufacturing laboratory.

43. A method for on-line manufacturing of a dental appliance for the mouth of a patient, comprising the steps of
(a) providing an image of the mouth of said patient;
(b) transmitting said image to a manufacturing laboratory to provide a transmitted image; and
(c) manufacturing said dental appliance by said manufacturing laboratory in accordance with said transmitted dental model image.

44. The method for on-line manufacturing of a dental appliance for the mouth of a patient of claim 43, wherein said dental image comprises a three-dimensional dental model image.

45. The method for on-line manufacturing of a dental appliance for the mouth of a patient of claim 43, comprising the further steps of:
(a) providing a menu of questions to a user soliciting specifying information for specifying a manufacturing process to produce said dental appliance for said patient; and
(b) transmitting by said user said specifying information to said manufacturing laboratory by way of the internet to create a user order.

46. The method for on-line manufacturing of a dental appliance for the mouth of a patient of claim 45, comprising the further step of manufacturing said dental appliance by said manufacturing laboratory in accordance with said transmitted specifying information.

47. The method for on-line manufacturing of a dental appliance for the mouth of a patient of claim 45, comprising the further step of determining a dental appliance image of said dental appliance in accordance with said specifying information.

48. The method for on-line manufacturing of a dental appliance for the mouth of a patient of claim 47, comprising the further step of determining said dental appliance image by said manufacturing laboratory and transmitting said dental appliance image to said user by said manufacturing laboratory.

49. The method for on-line manufacturing of a dental appliance for the mouth of a patient of claim 47, determining said dental appliance image by said user and transmitting said dental appliance image by said user to said manufacturing laboratory.

50. The method for on-line manufacturing of a dental appliance for the mouth of a patient of claim 48, comprising the further step of adjusting said specifying information in accordance with said dental appliance image to provide adjusted specifying information and manufacturing said dental appliance in accordance with said adjusted specifying information.
